(19) United States
(12) Patent Application Publication
(10) Pub. No.: US 2005/0160551 A1
(43) Pub. Date: Jul. 28, 2005

(54) Blade for a scraping device and method for manufacturing a blade of this kind

(75) Inventor: Peter Kochenrath, Remscheid (DE)

Correspondence Address: DREISS, FUHLENDORF, STEIMLE & BECKER, POSTFACH 10 37 62, D-70032 STUTTGART, DE

(73) Assignee: Joh. Clouth GmbH & Co. KG

(21) Appl. No.: 11/038,100

(22) Filed: Jan. 21, 2005

(30) Foreign Application Priority Data
Jan. 23, 2004 (DE) 10 2004 004 500.3

(51) Int. Cl. B08B 1/00

(52) U.S. Cl. 15/256.51

(57) ABSTRACT

The invention concerns a blade for a scraping device for a roller or a cylinder, in particular of a paper machine, a printing machine, a calender or the like, wherein the blade has a carrier material and at least one filler, wherein the filler is distributed in the carrier material in a graded manner. The invention also concerns a method for producing a blade of this type.

This application claims Paris Convention priority to DE 10 2004 004 500.3 filed Jan. 23, 2004 the entire disclosure of which is hereby incorporated by reference.

### BACKGROUND OF THE INVENTION

The invention concerns a scraping device blade for a roller or cylinder, in particular, in a paper machine, a printing machine, a calendar or the like, wherein the blade consists essentially of at least one carrier material and at least one filler. The invention also concerns a method for producing a blade of this type.

Scraping devices clean the surface of a roller or a cylinder. A scraping device of this type, when used in a paper machine, prevents a paper sheet, which is guided over a respective roller of the paper machine, from being wound about the roller when the sheet tears, rather leaves the roller at the intended location to pass e.g. into a collecting hopper. The scraping device must fulfill this task with 100% reliability, otherwise considerable disturbances would occur during paper production and, under certain circumstances, even damage to the paper machine. For this reason, the blade of the scraping device must always abut the surface of the respective roller. The plane of the blade thereby extends at an acute angle relative to the tangent of the contacting surface line on the roller.

To obtain a reliable scraping effect, the blade must have certain properties. It must reliably abut the surface of the roller over its entire length. This is effected by special holders which exert the required pressure onto the blade (DE 195 08 298 A1). Moreover, the blade structure must provide a certain stability, i.e. to prevent premature wear. WO-A-00 15 904 discloses a blade which consists essentially of plastic material with an added filler. The properties of the blade can be altered as desired through use of suitable additional substances. However, these additional substances increase the production cost of the blade.

It is therefore the underlying purpose of the invention to provide a blade an/or a method for producing a blade of this type which has the desired properties and can be produced less expensively.

### SUMMARY OF THE INVENTION

This object is achieved in accordance with the invention with a blade of the above-mentioned type in that the filler is distributed in a graded fashion in the carrier material.

The filler of the inventive blade is not uniformly distributed over the entire cross-section of the blade but is concentrated where the properties of the filler are required. If the filler is to reduce the frictional contact between the blade and the roller, e.g. of a paper machine, thereby reducing the generated wear, it is advisable to provide the filler in the region of the blade facet. In accordance therewith, the graded distribution of the filler change from the facet towards the remote clamping end of the blade. The blade thereby has the desired wear-reducing properties in the region of the facet, and the production costs are considerably reduced compared to conventional blades, since the amount of the required filling substances are fillers is considerably reduced compared to conventional blades in consequence of the fact that the filling substance must only be provided in a small region of the blade.

Another advantage consists in that the region of the blade facing away from the facet may be provided with another filler which may positively influence e.g. the elasticity, the compression strength or another property.

In a preferred embodiment, the amount of filler increases towards the facet. The increase may thereby be linear or in steps. A stepwise increase is advantageous in that the blade at the facet and at a region proximate the facet has the same or almost the same properties. With increased use, this blade displays no or nearly no deteriorating properties such that the scraping quality of this blade is guaranteed for a long period.

In accordance with a preferred embodiment, the amount of filler increases towards the facet from a region, which is separated from the facet by approximately 50% to 25%, in particular 33%, of the overall width of the blade. This blade can be used until the region provided with filler is worn, without having the properties of the blade change considerably.

The above-mentioned object is also achieved in accordance with the invention through a method with which the carrier material and the filler are injected into a mold.

The inventive blade is substantially produced through injection molding, wherein the materials, in particular the carrier material, are extruded into the mold.

In accordance with the invention, the carrier material and the filler are injection-molded into a rotatable mold, with the axis of rotation of the mold extending parallel to the facet and being located at a larger radial distance from it than the clamping end, and the mold is rotated after filling. Centrifugal forces act on the carrier material and the filler in response to rotation of the mold, whereby the materials are separated or segregated to a defined degree, with the material having the higher specific weight being forced towards the facet. The concentration of the filler in the region of the facet can thereby be increased in a simple manner to provide this region of the blade with the desired properties.

The carrier material and the filler may thereby be mixed before being injected or the filler may be injected first and then the carrier material. In particular, fillers or filling materials are used whose specific weight is larger than that of the carrier material.

In another embodiment of the method, the mold is filled via at least two injection heads, wherein the injection heads are distributed over the width of the blade, and the filler or carrier material including filler are injected in the region of the facet. The filler may be added or injected using these two injection heads such that the filler is graded over the cross-section of the blade.

In a preferred embodiment, the blade is produced through a continuous process, wherein the processing direction corresponds to the longitudinal direction of the blade. These blades have constant property gradients over their entire length, which is particularly advantageous for paper machines having a large sheet width, since it is no longer necessary to provide a scraping device with a plurality of short blades. One single blade is sufficient which is uniformly worn over its entire length.

The mold is preferably filled from the clamping end towards the facet to ensure that the initially filled-in material is disposed in the region of the facet, and the blade can then be safely cut to the desired width in the region of its clamping end without removing filler-containing material.

In accordance with the invention, a mixing head, in particular, having several valves, is used for filling the mold. There are conventional mixing heads of this type for processing different materials which can be exactly controlled to ensure the layered structure of the blade.

In one embodiment, the mixing head is moved in the longitudinal direction of the mold. In another embodiment, several injection nozzles are provided at different levels for filling the mold, wherein the mold is moved relative to the injection nozzles. A low-viscosity carrier material is preferably used in which the filler can move relatively easily.

Further advantages, features and details of the invention can be extracted from the following description giving details of particularly preferred embodiments with reference to the drawing. The features shown in the drawing and mentioned in the description and the claims may be essential to the invention either individually or collectively in arbitrary combination.

### BRIEF DESCRIPTION OF THE DRAWING

FIG. 1 shows a schematic view of a scraping device with clamped blade;

FIG. 2 shows a perspective schematic view of a first injection mold;

FIG. 3 shows a schematic vies of a second injection mold;

FIG. 4 shows a schematic view of a third injection mold; and

FIG. 5 shows a schematic view of the production of a blade in continuous operation.

### DESCRIPTION OF THE PREFERRED EMBODIMENT

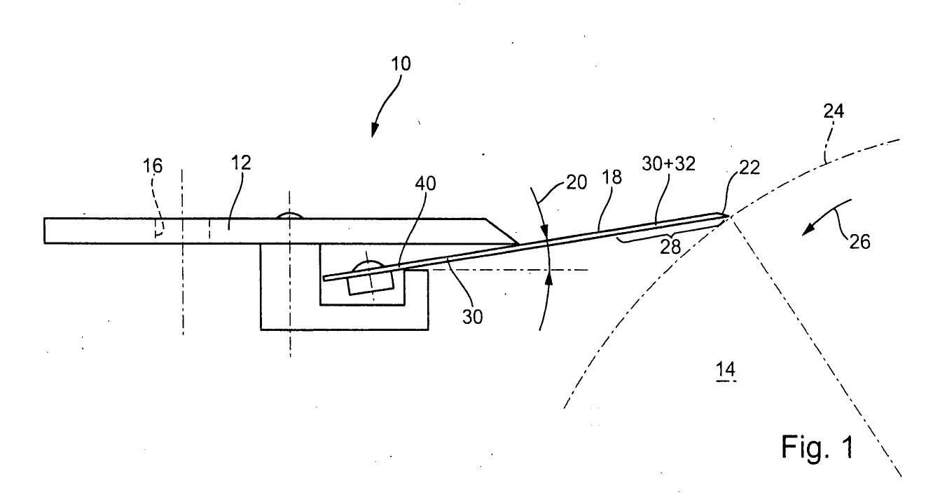

Reference numeral 10 in FIG. 1 designates a scraping device which comprises a blade holder 12 which can be screwed to a roller from in the direct vicinity of a roller 14. The blade holder 12 has an associated bore 16. A Blade 18 is introduced into the blade holder 12, and is disposed at an angle 20 with respect to the plane of the blade holder 12. The facet 22 of the blade 18 abuts the periphery 24 of the roller 14 which rotates in the direction of arrow 26. To limit the wear of the blade 18, the blade 18 has different properties in the region 28 of the facet 22 than in other regions. This is effected through adding a suitable filler 32 to the blade 18 in the region 28. This filler 32 increases e.g. the wear resistance and reduces friction relative to the roller 18. The blade 18 generally comprises a carrier material 30 to which the filler 32 was added to obtain these particular properties.

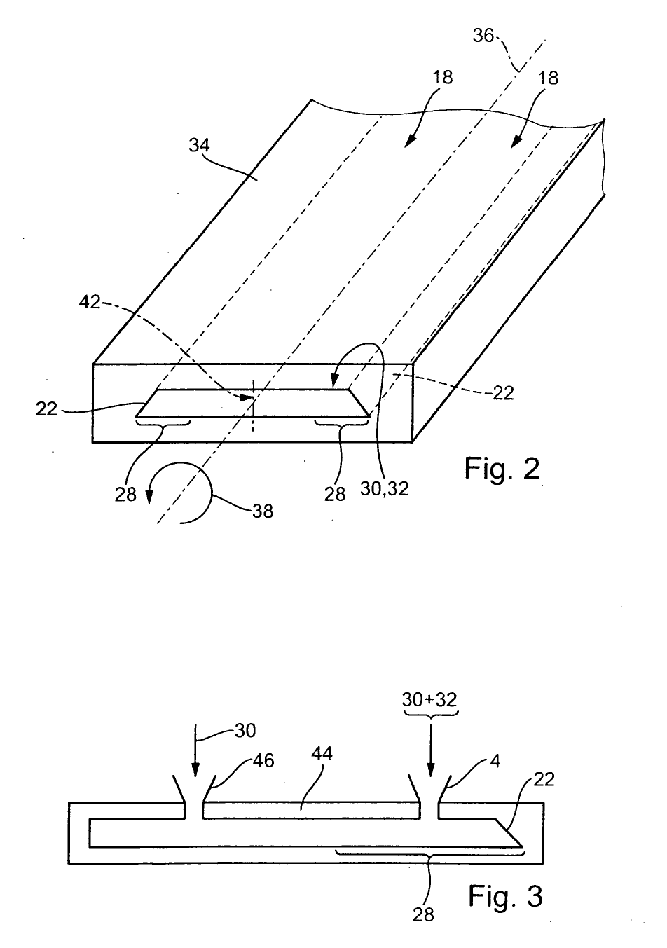

FIG. 2 shows an injection mold which is designated in total with 34, into which the carrier material 30 and the filler 32 can be introduced with or without pressure. The carrier material 30 and the filler 32 can thereby be filled in as mixture, or the materials 30 and 32 may also be introduced separately, in particular, one after the other. After filling, the injection mold 34 is rotated about an axis of rotation 36 which is indicated by arrow 38, thereby at least partially segregating the materials 30 and 32, such that the material having the larger specific weight, i.e. the filler 32, is concentrated in the region 28 of the facet 22. A blade 18 having graduated properties is thereby produced, which has e.g. a particularly high wear resistance in the region 28 of the facet 22, and in the other region, in particular in the region of the clamping end 40, has a high elasticity coefficient to reduce the risk of fracture. After hardening of the materials 30 and 32 in the injection mold 34, two blades 18 are produced by a central longitudinal cut 42 as is indicated in FIG. 2.

FIG. 3 shows a second embodiment of an injection mold 44 into which the carrier material 30 and a mixture of carrier material 30 and filler 32 are filled in at different locations via corresponding inlet openings 46, thereby also concentrating the fillers in the region 28 of the facet 22.

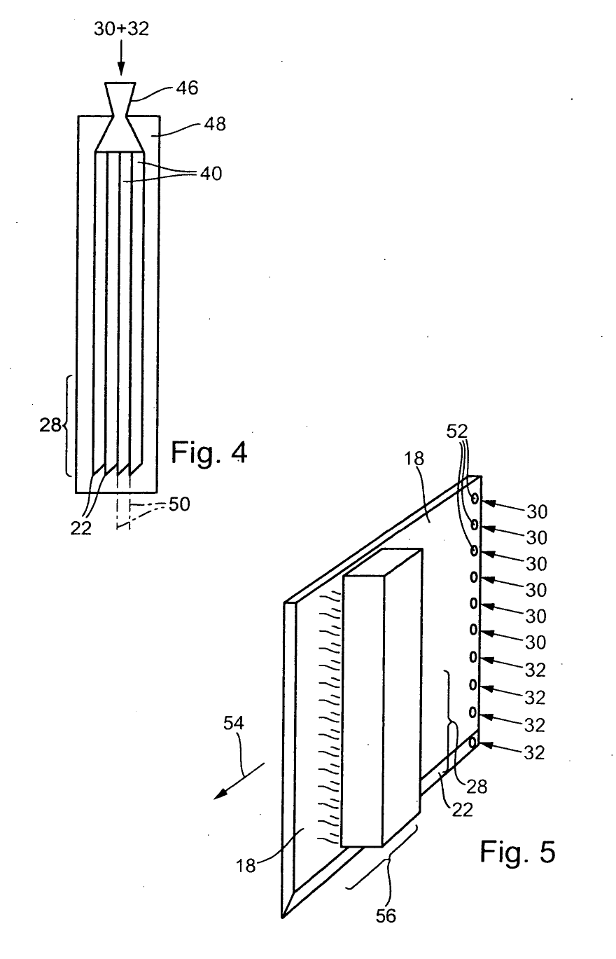

FIG. 4 shows a third embodiment of an injection mold 48 with an inlet opening 46 provided in the region of the clamping ends 40 of the blades 18 into which the carrier material 30 and the filler 32 are introduced. The filler 32 or a mixture of carrier material 30 and filler 32 is/are initially filled in until the region 28 opening into the facet 22 is filled and the rest of the injection mold 44 is subsequently filled with carrier material 30. After hardening, the blades 18 are produced through separating cuts 50. The injection mold 48 may also be designed to produce individual blades 18. Moreover, the materials 30 and 32 can be filled in using a mixing head.

FIG. 5 shows a method for producing an endless blade 18 in continuous operation, wherein the carrier material 30 and the filler 32 are injected via a plurality of injection nozzles 52. The filler 32 is thereby mainly supplied in the region 28 of the facet 22. The materials 30 and 32 advance, in the direction of the arrow 54, to a heating zone 56 where they are heated by a heating element 58, whereby the materials 30 and 32 are hardened. The finished blade 18 can then be cut to the desired length.

The blade 18 therefore has fillers concentrated in the region 28 of the facet 22 such that its properties in this region differ from those of the other region.

1. A scraping device blade for a roller or a cylinder, the blade having a facet and a clamping end opposite the facet, the blade consisting essentially of:
at least one carrier material; and
at least one filler, wherein said filler is distributed in a graded manner in said carrier material.

2. The blade of claim 1, wherein the blade is structured and dimensioned for use in a paper machine, a printing machine or a calendar.

3. The bald of claim 1, wherein graded distribution of said filler changes from the facet towards the clamping end of the blade.

4. The blade of claim 3, wherein an amount of said filler increases towards the facet.

5. The blade of claim 4, wherein an amount of said filler increases linearly.

6. The blade of claim 4, wherein an amount of said filler increases towards the facet from a region which has a separation from the facet of approximately 50% to 25% of an overall width of the blade.

7. The blade of claim 6, wherein said separation is 33% of said overall width of the blade.

8. A method for producing the blade of claim 1, wherein said carrier material and said filler are injected into a mold.

9. The method of claim 8, wherein said carrier material and said filler are injection-molded into a rotatable mold, wherein an axis of rotation of the mold extends parallel to the facet and has a larger radial separation therefrom than the clamping end, wherein the mold is rotated after filling.

10. The method of claim 9, wherein said carrier material and said filler are mixed before injection.

11. The method of claim 9, wherein said filler has a higher specific weight than said carrier material.

12. The method of claim 9, wherein the mold is filled using at least two injection heads, wherein the injection heads are distributed over a width of the blade and said filler or said carrier material with said filler is/are injected proximate the facet.

13. The method of claim 12, wherein the blade is produced through continuous production, wherein a direction of production passage corresponds to a longitudinal direction of the blade.

14. The method of claim 8, wherein the mold is filled from the clamping end towards the facet.

15. The method of claim 14, wherein a mixing head is used for filling the mold.

16. The method of claim 15, wherein the mixing head is moved in a longitudinal direction of the mold.

17. The method of claim 14, wherein several injection nozzles are provided at different levels for filling the mold.

18. The method of claim 17, wherein the mold is moved relative to the injection nozzles.

19. The method of claim 8, wherein said carrier material has a low viscosity.
